(19) United States
(12) Patent Application Publication
(10) Pub. No.: US 2022/0314356 A1
(43) Pub. Date: Oct. 6, 2022

(54) DYNAMIC MIXTURE OF SHIELDING GASES

(71) Applicant: Linde GmbH, Pullach (DE)

(72) Inventor: Thomas AMMANN, München (DE)

(21) Appl. No.: 17/597,008

(22) PCT Filed: Jul. 6, 2020
(86) PCT No.: PCT/EP2020/025320

§ 371 Date: Dec. 22, 2021

(30) Foreign Application Priority Data
Jul. 8, 2019 (EP) 19020417.2

(51) Int. Cl. B23K 9/16; B23K 9/32; B23K 35/38

(52) U.S. Cl. CPC B23K 9/164; B23K 9/325; B23K 35/383

(57) ABSTRACT

The invention relates to a method for the dynamic feeding of shielding gas, comprising feeding a shielding gas to a component in a welding operation, sending the temperature of a region of the component; and setting a composition of the shielding gas according to the sensed temperature.

The invention relates to a method for supplying shielding gases in a welding operation, in particular for dynamically mixing shielding gases during arc welding.

The composition of the welding shielding gas used depends on the materials and processes used. In the case of metal inert gas welding (MIG), this can concern, for example, inert gases, such as argon, or an argon-based gas mixture. Moreover, additional constituents that have an influence on the process can be added to the shielding gas; for example, in the case of metal active gas welding (MAG), gases that are highly reactive and that undergo corresponding reactions with the weld pool are added selectively.

Depending on the material used, such a method is carried out in a closed shielding gas atmosphere or in air. Reactive materials, such as titanium alloys, must remain in an inert atmosphere after the direct welding operation until they have cooled below a threshold temperature below which oxidation no longer takes place. With other materials however, such as steels, a subsequent shielding gas supply after the welding operation is not necessary.

Welding processes are increasingly important not only as joining processes for connecting components but also as additive manufacturing processes, such as so-called wire arc additive manufacturing (WAAM). In this manufacturing process, a three-dimensional component is additively manufactured by repeated application of weld beads by an arc welding process. A component blank close to the final contour is thus obtained, which can then be machined or further processed in any other way. In this build-up welding, however, the heat balance in the component can present problems since not only is the material melted on and off by the arc, but large amounts of heat are also introduced into the component that has already been produced. Depending on the thermal conductivity of the material used, this heat is more or less quickly dissipated into the base plate. In the case of poorly thermally conductive materials, the heat may build up in the component as construction progresses and lead to excessive softness, undesired structural changes or premature melting. This then requires additional external cooling and/or longer waiting times before the next weld layer.

The invention is therefore based on the object of being able to better control the heat in the component during a welding operation in order to prevent delays, additional interventions in the process, or even manufacturing errors.

This object is achieved in that a method for the dynamic supply of shielding gas is proposed, comprising at least the following steps: supplying a shielding gas to a component in a welding operation, detecting the temperature of a region of the component, and determining a composition of the shielding gas as a function of the detected temperature. In this way, the process parameters of the welding operation can be influenced by a temperature-dependent change in the composition of the shielding gas used.

Determining the composition of the shielding gas preferably comprises a change in the composition such that the thermal conductivity and/or the ionization energy of the shielding gas changes. In this way, the heat input into the component can be controlled or at least influenced so that various advantages are achieved. In particular, in the case of an additive process, a reliable process start and good melting behavior can thus be achieved even at an early stage of construction, while too high a heat input into the component is prevented in later construction stages. Reduced cooling times and thus overall shorter production times are thus also possible.

In exemplary embodiments, the method may further comprise a control signal correspondent to the determined composition being output to a gas mixing unit which is set up to mix at least two gas components in accordance with the composition. The composition of the shielding gas can thus comprise at least these two components but optionally also more components. By this control, the composition can be adjusted accordingly at any time. For example, a first component of the composition may be argon or an argon-based gas mixture, and a second component may be helium. In the course of the welding process, the helium content could then, for example, be up to 100% and/or initially 70%, from time to time 50%, and at the end of the production period 30%. As a result of the increased thermal conductivity of the resulting shielding gas, a high helium content can increase the heat input into the component, whereas in later method steps, in which a high heat input is no longer desired nor necessary, only the first component or only a lower helium content can be used.

Especially in the example of a wire build-up welding operation, a content of 30-60% helium in the composition of the shielding gas could be used at the beginning of the build-up welding operation. Later on in building-up the component, this content can be increasingly reduced. The improved control over building-up and material bonding enables a better closeness to final contour of an additively manufactured component, which in turn shortens later production steps and leads to lower costs overall.

Determining the composition of the shielding gas can, for example, comprise comparing the detected temperature to at least one predetermined temperature value, and changing the composition of the shielding gas in accordance with predetermined specifications if the predetermined temperature value is exceeded or undershot. Determining the composition of the shielding gas may also comprise calculating the composition of the shielding gas by means of a specified assignment or function, wherein the detected temperature is a variable of the assignment or function.

In particular, the method steps may be executed by a processor, controller, or computer, wherein the instructions for performing the method steps may be stored in the form of a computer program. Such a program can also be implemented in a simple manner on an existing control unit for a welding process.

In addition, a device for dynamically supplying shielding gas is also proposed, comprising at least one control unit configured to carry out the method steps described above, and a gas mixing unit configured to deliver at least a first and a second component of a shielding gas on the basis of a control signal, wherein the control signal is transmitted from the control unit to the gas mixing unit; and a temperature measurement device configured to detect the temperature of a component and to pass the temperature to the control unit.

### FIGURES

The invention is described in more detail below with reference to the drawing, wherein

FIG. 1 schematically shows a system for gas-shielded welding in accordance with an exemplary embodiment; and

FIG. 2 shows a flow chart of an exemplary method in accordance with the invention.

### DESCRIPTION OF EXEMPLARY EMBODIMENTS

The invention can basically be applied to any method that runs under the supply of shielding gases and in which heat input in the component is to be monitored. A method according to the invention is in particular suitable for any gas-shielded arc welding method, i.e., not only conventional connection welding using shielding gas (metal shielding gas welding, MSG) but also additive manufacturing methods, such as WAAM.

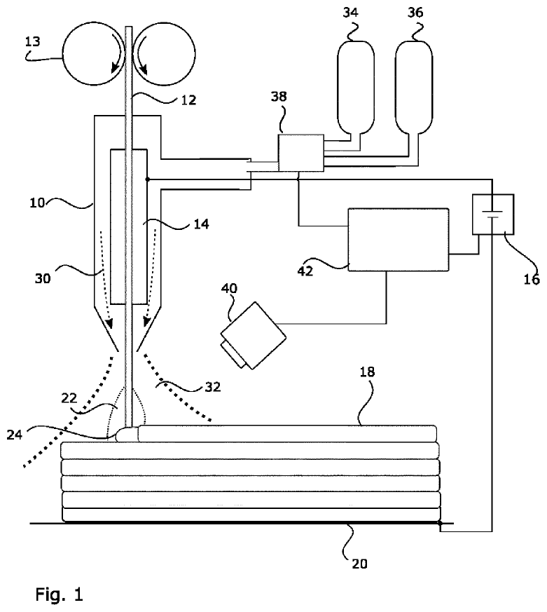

The invention is now described in more detail using the example of an additive welding build-up method, such as the already mentioned WAAM method. FIG. 1 schematically shows an exemplary system for arc build-up welding in accordance with the invention. In this case, a welding wire 12 which acts as a melting electrode is guided within a welding torch 10. The welding wire 12 runs inside a contact sleeve or current sleeve 14 which is in connection with a power source 16. As a result, an electrical arc 22, which leads to the melting of the welding wire 12, is ignited between the welding wire 12 and the electrically conductive component 18 which is being built up on a base plate 20. The wire 12 is continuously fed in via motorized guides, e.g., wire feed rollers 13, on which the welding wire runs. The melted material 24 is deposited in the form of weld beads which in the WAAM method form the component in a suitable manner by movement of the torch or of the component beneath the torch.

A shielding gas 30, for example an inert gas, is supplied around the wire 12 in the torch 10 in order to protect the weld pool 24 from oxidation. The shielding gas 30 flowing out of suitable nozzles forms a layer or shielding gas blanket 32 in the region of the weld pool 24 or in other desired regions of the component 18. In the present embodiment, the shielding gas 30 is supplied at least at times as a combination of several components 34, 36, which are mixed or adjusted in quantity by a controllable gas mixing unit 38. Moreover, a device for temperature measurement 40 is provided, which can detect the temperature of the component 18 in a desired region, for example in the region of the weld pool 24 or also at any specified distance from the weld pool, for example in the region of respectively cooling weld beads. The temperature measurement device 40, the gas mixing unit 38, and the power source are preferably connected to a control unit 42 which controls these elements.

Depending on the method, instead of the consumable electrode 12 shown, which is guided within the torch, a non-consumable electrode, such as in tungsten inert gas welding, may also be used, for example, so that the wire outside the torch is correspondingly supplied continuously in the region of the arc 22. All materials customary in the field can be used as materials for melting and/or as a base plate for a joining or build-up method, i.e., for example, various steels, aluminum, titanium and nickel alloys, cobalt-chromium alloys, noble metal alloys, and many others.

By selectively combining constituents of the shielding gas used, it is now possible to influence the heat conditions. The addition of helium to an argon-based shielding gas causes, for example, more heat to be introduced into the component by the arc due to the high thermal conductivity of helium. As a result, the arc power can also be reduced accordingly and/or welding can be faster so that the efficiency of the operation is increased. The additional heat input can also be used to facilitate bonding, which is advantageous in particular in the case of highly thermally conductive materials, such as aluminum, or very viscous materials, such as high-alloy stainless steels.

This can be exploited in order to optimize thermal behavior in the component during the course of a welding operation or an additive manufacturing operation. Particularly at the beginning of an application process in which the base component (e.g., a base plate 20) is still cool, a higher heat input into the component is advantageous in order to achieve better bonding of the materials. However, if, after several weld layers, building-up the component has already progressed further, an increased heat input can be disadvantageous since the component heat already present already sufficiently supports the melting. In order to achieve this, the composition of the shielding gas can be adjusted dynamically during the course of the welding operation as a function of the temperature of the component (or of specific component regions).

Any suitable device 40 can be used for temperature measurement. In accordance with a preferred embodiment, the temperature of the component is detected by a non-contact temperature measurement device. In this way, the component temperature can be determined as accurately as possible and without disrupting the welding operation, wherein measurement can take place continuously or at specific time intervals. Possible measuring methods for such a measurement include, for example, measurement on the basis of an infrared temperature measurement by means of a pyrometer in which the temperature is deduced from infrared radiation emitted by the component, or other suitable methods. In principle, however, local measuring methods, such as temperature sensors or others, are also conceivable. Depending on the design of the controller, an absolute temperature can be measured or only a relative change in temperature.

The temperature measurement device 40 can be firmly attached in a region of the manufacturing system or can also be connected to the welding torch 10, for example in the form of an additional module attached to the torch. The measured temperatures can be transmitted directly to a control unit 42 via corresponding connections or cables. Alternatively, the temperature measurement device 40 may also be connected to a control unit via wireless or wired interfaces.

The controller, which performs the adjustment of the gas composition and controls the corresponding elements (such as valves) in a gas mixing unit 38, can be a dedicated shielding gas controller. However, the controller is preferably combined with the control unit 42, which also controls the welding process, i.e., for example, the electrode current, the speed of movement and/or the direction of movement of the torch 10 and/or of the component 18 in at least partially automated manufacturing, the speed of the wire feed 13, and further process parameters. In particular, it can also be a central control unit which controls the entire manufacturing process, for example the automatic component build-up by means of an additive process, similarly to a 3D printer. In this case, the control can take place, for example, on the basis of a microprocessor or FPGA (field programmable gate array) or can be implemented in a simple analog control unit. The entire control may likewise take place on a software basis in a suitable processor. In each embodiment, suitable connections and interfaces may be provided so as to be able, for example, to connect temperature sensors, torches, or gas mixers to the controller in a simple manner. Display elements and input devices may likewise be present, for example, in order to be able to intervene manually in the control or in order for a user to be able to query and input process parameters that are used for control.

Various shielding gases and gas mixtures are known per se in the art and can be used as desired in conjunction with the present invention. A mixture of two or more elements or compounds is referred to as a gas mixture. Gases or gas mixtures that have different thermal conductivities are preferably used here so that thermal conductivity is also changed accordingly when the respective proportions of gas components in the overall composition of the shielding gas are changed. If the thermal conductivities of the components differ greatly, even a small change in the composition can lead to a significant change in the thermal conductivity of the resulting mixture so that a corresponding adjustment of the shielding gas mixture used results in a sufficient effect for the heat distribution in the component.

It is also possible for a control unit to calculate the expected thermal conductivity of a gas mixture on the basis of stored specifications and to optionally additionally calculate based thereon the expected temperature change in the component when the shielding gas composition changes, so that, using these results, the regulation can then determine the gas composition, e.g., on the basis of a setpoint value for the component temperature. Instead of or in addition to thermal conductivity, other changes in the shielding gas effect can also be included in the determination of gas composition, e.g., the reactivity of the shielding gas during active-gas welding.

In an exemplary embodiment, for example, an argon-based welding shielding gas, i.e., a gas whose main constituent is argon, can be used, wherein optionally further constituents, such as CO2, O2, N2, or H2, may also be admixed with the inert gas, preferably in small quantities. This argon-based welding shielding gas can be used as the first basic component of the shielding gas. As a second component of the shielding gas, helium, for example, can then be used, whose high thermal conductivity can improve the aforementioned effects, such as higher heat input into the component. In general, each gas component may itself also comprise a mixture of several gases. In the course of the process, the helium content in the entire shielding gas can be, for example, between 0 and 60 vol. % helium, preferably between 0 and 50 vol. % or even between 0 and 25 vol. %, while the remainder can be argon or an argon-based gas mixture. However, adjusted to the process conditions, other gas components or proportions are also possible. In specific phases of the method, for example at the beginning, the helium content could thus be increased to up to 100%, and the content of argon or other base gases could then be increased or the helium content decreased.

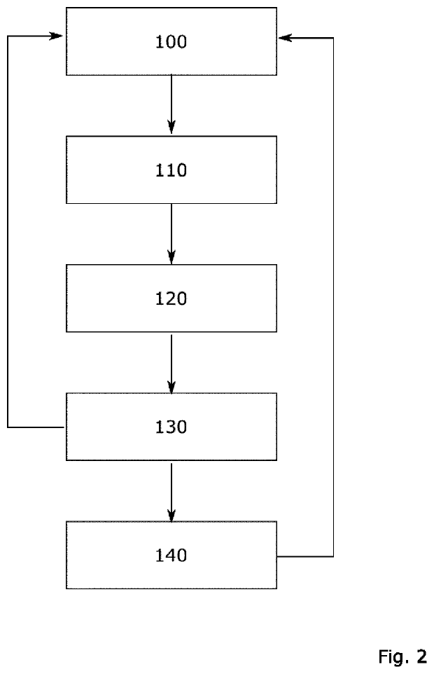

FIG. 2 shows a flow chart of exemplary method steps of a method according to the invention. At the beginning of a welding process, such as a WAAM build-up process, a preset mixture with a high helium content, for example with 50 vol. % helium and 50% argon, can then be used as shielding gas. The other parameters of the welding process can also be specified, and the welding process can be started in step 100 with these parameters and the preset shielding gas composition. The temperature of a component region is now measured continuously or at intervals in step 110. The measured temperature value is passed to a control unit and processed there in step 120, for example by comparison with a threshold value, or by insertion into a function which outputs a resulting shielding gas composition. The determination of the gas composition thus obtained is passed in the form of a control signal to the gas mixing unit 38 in step 130. The welding method 100 is continued with the shielding gas composition thus controlled. In the course of the method, the helium content can thus be reduced continuously or in stages as a function of the measured component temperature; for example, threshold temperatures could be determined at which the helium content is reduced to 30%, 20%, and finally 0%, or close to 0% (e.g., between 0.5% and 3%), or the helium content can be adjusted continuously as a function of the measured temperature. This can be a linear or non-linear relationship between temperature and gas composition. Instead of a function, an assignment of temperature and content values can also be specified, for example in the form of a stored assignment table. In the case of a continuous temperature measurement, the gas composition can accordingly also be changed continuously, or temperature measurements can be evaluated at specified time intervals and the gas composition can subsequently be adjusted. However, even in the case of a continuous temperature measurement, an adjustment of the gas components that is only carried out in stages may likewise be selected. The corresponding specifications, such as threshold temperatures, functions and optional parameters, such as time intervals for temperature measurement and gas adjustment, can be stored in the control unit, e.g., even specifically for each process, and can be changed or updated as needed. Alternatively, similar compositions can be specified for any processes that are adjusted only as a function of the temperature.

Instead of admixing helium to argon or argon-based gases, suitable other gases could also be mixed. In particular when using steel as a material, an argon-based gas could, for example, be used as the first gas component and a suitable quantity of carbon dioxide, CO₂, could then be dynamically admixed. As in the previous example, a high CO₂ content could then be provided at the beginning of a build-up process, which content is reduced in the course of welding build-up in stages or continuously. In this way, a good heat input or penetration is again initially achieved and excessive heat input into the component is later prevented. The suitable proportion of CO₂ can be determined depending on the material, wherein, for example, in the case of stainless steel, a CO₂ content of 0 to 4% can preferably be provided, while in the case of an unalloyed steel, higher CO₂ contents of up to 25% can be advantageous. In a similar manner, a suitable combination of several gas components can thus be selected for each selected material, the proportions of which are variably adjusted both throughout and also in relation to their minimum and maximum proportions in the gas mixture.

Different temperature thresholds can also be determined for different sections of a manufacturing method so that the same component temperature can also result in different gas compositions depending on the process section. In one embodiment of the invention, a feedback control circuit can also be used, which regulates the gas composition as a function of the temperature, wherein the proportion of one or more gas components is used as a control variable in the regulation and a setpoint temperature to be maintained (or a broader temperature range) of the component is specified as a target value.

In a further exemplary embodiment, the composition of the shielding gas may also comprise three or more components, all or only some of which are dynamically adjusted in a gas mixing unit 38. For example, two components can be used in a fixed ratio, while the proportion of the third component is adjusted as a function of the temperature. Two components can likewise be adjusted; for example, one component could also be continuously reduced as the temperature rises, while a further component is additionally added in a fixed or variable proportion once a specific threshold temperature is exceeded or undershot. Alternatively, one component could also be adjusted as a function of the temperature, while in order to change further process conditions, another component (e.g., oxygen) is dynamically changed on the basis of other parameters, e.g., in order to increase the melting rate. Following the aforementioned examples, a gas mixture can, for example, be provided, in which argon or an argon-based welding shielding gas is selected as the first gas component and helium and CO₂ are respectively admixed in a variable proportion as two further components adjusted to the temperature and/or the process flow so that a gas mixture of (at least) three components is present.

Even if only two gas components are used, either one gas component can be supplied continuously in the same quantity and the second gas component can be correspondingly throttled back or increased until the desired proportionate composition in the mixed gas of the two components is achieved, or both gas components can be actively throttled or controlled, for example via electro-magnetically or pneumatically operated throttle valves. Conventional gas mixing stations can also be used insofar as they can be electronically controlled by the control unit with suitable control signals. A control signal is to be understood to mean any signal that is capable of triggering a corresponding control of the gas components in a gas mixing unit, i.e., for example, an analog voltage signal that is applied to an electromagnetic valve or a blocking device. In this case, corresponding controllable valves or shut-off or regulating devices for the gas quantity can be provided only for one or for several gas components.

The ready-mixed shielding gas mixture can preferably be supplied to the component, or, in a simpler embodiment, the respective proportions of the gas components can be supplied individually in the region of the torch or component and the mixture achieved by the gas flow.

Since the heat distribution in the component has an influence on stability, on the built-up layer geometries, and on the oxidation processes of the layers produced, in particular in the case of additive manufacturing, these effects can also be further exploited by selectively targeting a specific temperature for a process section, optionally even only temporarily. For example, the gas composition could be changed either under automatic control or by manual intervention such that the component temperature is temporarily raised and the temperature control or the control of the gas composition required for this purpose then falls back to the specified course, for example in order to achieve a different melting behavior of the wire at a specific location.

While, as described above, the gas composition of the shielding gas can be made directly dependent on the temperature, it is also possible in a more complex embodiment to further process the measured temperature first and then to adjust the gas composition based thereon. For example, from the measured temperature and specified parameters, such as the wire material used, the wall and layer thickness of the built-up materials, the speed of the material deposition or of the wire feed, and further characteristics, such a control could calculate suitable parameters that model the thermal behavior in the component. In this way, in a controller, the thermally conductive behavior of the built-up layers could be estimated, for example, from temperature measurements and the gas composition could be adjusted more precisely as a function of the expected heat development. This enables an optimized adjustment of the shielding gases used.

It would also be possible to measure the component temperature not directly in the region of the weld pool but to arrange a temperature sensor or another measuring device at the edge of the component, for example, and to estimate the component temperature in the region of the weld pool or in other regions of interest on the basis of specified thermal conductivity models, and to then adjust the gas composition based thereon.

Furthermore, instead of precisely controlling the gas composition by actively mixing several components, the gas composition in a simpler embodiment could also be changed by switching between two prescribed gas mixtures when the shielding gas is supplied. For example, a temperature threshold can again be used as a trigger condition for the switching. Ready-mixed shielding gas mixtures can thereby be used in a simple manner, and only one controllable switching option which can switch between two (or more) gas supply lines needs to be present. For example, a first argon-based gas without relevant additives could be used as the base gas, while a second gas mixture with a helium content is used as shielding gas under specific conditions, such as at the start of the process, and the controller only switches between the supply of these two shielding gases as needed.

In an exemplary embodiment, it is also conceivable to control the gas composition substantially on the basis of a time sequence. This is particularly suitable if the welding process also takes place under automatic control so that it is known beforehand in which process state the welding process is. In this way, the current temperature does not need to be monitored or monitored continuously and nevertheless enters the control indirectly through knowledge of the process conditions.

For example, such a control can also be recorded or adjusted on the basis of a standard process that has been run through and in which temperatures and optionally further process parameters are monitored in order to optimally adjust the gas composition. Temperature measurement and control can take place in this case as in the above examples. In subsequent runs with an identical or the same process sequence, such a system can then automatically adjust the composition without further measurements. Of course, instead of pure timing control, it is also possible to use a control on the basis of currently running method steps in a welding process if, for example, a torch is automatically moved to specific locations on the material (or, conversely, a component is moved along beneath the torch).

However, it is likewise possible to further refine or adjust such a coarse time-dependent control or process-step-dependent control of the gas composition by monitoring temperature measurement data, i.e., to combine a time-dependent and temperature-dependent control.

In further exemplary embodiments, parameters of the welding torch 10 itself can be adjusted in step 140 of FIG. 2, e.g., as a function of the measured temperatures and/or as a function of the control of the shielding gas composition. These parameters in turn flow to the respectively controlled elements, e.g., power source, wire feed, or other elements, and the method is continued with these changed parameters. All process parameters can thus be adapted to one another ideally and even at short notice. In particular, the parameters of the torch or of the power source 16 of the welding device can be set as a function of the controlled gas composition. For this purpose, corresponding functions or assignments can also be available for the proportions of the gas components and the current used, and the power source 16 can be controlled based thereon.

In an exemplary system, specifications, such as materials used, can be stored and retrieved, or can also be flexibly queried or input in a user dialog so that the optimal composition is used for any process. For example, it is conceivable to store various temperature thresholds or various functions for the dynamic gas composition for different materials or particular predetermined workpieces, which can then be retrieved during operation. Parameters can likewise be changed as a function of the device connected to the system, for example in that the type of welding device or torch is selected by the user or is automatically recognized upon connection.

Instead of an integrated or associated shielding gas nozzle on the torch as described above, embodiments of the invention may alternatively also be implemented in a chamber or in an otherwise at least partially closed region, into which shielding gas is introduced so that substantially the entire chamber is filled with shielding gas. Either the complete component or partial surfaces to be processed can be introduced into the chamber. Likewise, mobile cover elements with or without an integrated torch can be placed on a component and hold the shielding gas in place, wherein one or more shielding gas nozzles can be integrated appropriately into the cover element. In all cases, all embodiments of the dynamic shielding gas mixture can be used as described above.

It is likewise conceivable to arrange a plurality of nozzles on a component and/or on a torch, through which nozzles identical or different shielding gas mixtures can then be delivered to the component. In this way, for example, a different shielding gas mixture can be supplied directly to the weld pool than to already cooling component locations, to which shielding gas still need to be applied as they cool below the oxidation temperature. Here, too, the controller can correspondingly dynamically control one or more shielding gas mixtures as a function of the temperature. Optionally, several temperature measurement devices can also be provided for this purpose, wherein the temperature is measured once in the region of the torch and the temperature is measured once in a more distant region for cooling, and the gas composition is adjusted accordingly, or the temperature is taken into account only for the torch region. In this way, it can be ensured that, for example, the shielding gas in the vicinity of the weld pool is provided at times with additional gas components, for example helium, while a more cost-effective shielding gas without helium content is used further away for the cooling phase or for filling the chamber or cover hood. In general, the necessary gas nozzles can either be provided separately, for example for attachment as a drag nozzle, or be integrated directly with the torch.

It goes without saying that all of the aforementioned variants and options may also be combined with one another or transferred to other methods. For example, all of the various control principles and method steps can also be used in combination to determine the suitable gas composition. In this case, gas components and gas mixtures other than those described can be used and the examples for the temperature-dependent change in the composition can be applied to them. In particular, wire build-up welding processes have been described in detail by way of example, but the method according to the invention for dynamic gas mixing is likewise suitable for other known methods that require the use of shielding gases and/or active gases, such as connection welding, powder build-up welding processes with various heat sources, laser sintering with powder or wire material, generally build-up welding for coating processes, various fully mechanical or automated welding methods, such as MIG (metal inert gas welding), MAG (metal active gas welding), TIG (tungsten inert gas welding) and plasma welding, laser welding and electron beam welding, as well as other methods known in principle.

In addition to the gases and gas mixtures mentioned, other gases that have the required properties may likewise be used. The structure of a system depends on the materials and gases used, on the joining or build-up methods used, and can be varied in many ways.

### REFERENCE SIGNS

10 Torch
12 Wire electrode
13 Wire feed
14 Current sleeve
16 Power source
18 Component
20 Base plate
22 Arc
24 Weld pool
30 Shielding gas
32 Shielding gas blanket
34 First gas component
36 Second gas component
38 Gas mixing unit
40 Temperature measurement device
42 Control unit

1-13. (canceled)

14. A method for the dynamic supply of shielding gas, comprising
supplying a shielding gas to a component in a welding operation,
detecting the temperature of a region of the component; and
determining a composition of the shielding gas as a function of the detected temperature.

15. The method according to claim 14, wherein determining the composition of the shielding gas comprises a change in the composition such that the thermal conductivity and/or the ionization capability of the shielding gas changes.

16. The method according to claim 14, further comprising:
outputting a control signal correspondent to the determined composition to a gas mixing unit configured to mix at least two gas components in accordance with the composition.

17. The method according to claim 14, wherein determining the composition of the shielding gas comprises:
comparing the detected temperature to at least one predetermined temperature value, and changing the composition of the shielding gas in accordance with predetermined specifications if the predetermined temperature value is exceeded or undershot.

18. The method according to claim 14, wherein determining the current composition of the shielding gas comprises:
calculating the composition of the shielding gas by means of a specified assignment or function, wherein the detected temperature is a variable of the assignment or function.

19. The method according to claim 14, wherein the composition of the shielding gas comprises at least two components.

20. The method according to claim 19, wherein a first component of the composition is argon or an argon-based gas mixture, and wherein a second component is helium.

21. The method according to claim 20, wherein the proportion of helium in the course of the welding operation is up to 100%, or between 0-70%, or between 0 and 50%, or between 0 and 30%.

22. The method according to claim 14, wherein the welding operation is a wire build-up welding operation, and wherein a proportion of 30-60% helium in the composition of the shielding gas is used at the beginning of the build-up welding operation.

23. The method according to claim 14, wherein a component of the composition is CO₂, and wherein the proportion of CO₂ during the course of the welding operation is between 0-25%, or between 0 and 10%, or between 0 and 4%.

24. The method according to claim 14, further comprising changing parameters of a welding torch used for the welding operation on the basis of the determined composition of the shielding gas.

25. A computer program product comprising instructions which, when the program is executed by a processor, cause the processor to execute the method according to claim 14.

26. A device for the dynamic supply of shielding gas, comprising:
a control unit configured to carry out the method according to claim 14,
a gas mixing unit configured to deliver at least a first and a second component of a shielding gas on the basis of a control signal, wherein the control signal is transmitted from the control unit to the gas mixing unit; and
a temperature measurement device configured to detect the temperature of a component and to pass the temperature to the control unit.
